(19) United States
(12) Patent Application Publication
(10) Pub. No.: US 2014/0139479 A1
(43) Pub. Date: May 22, 2014

(54) ELECTRONIC DEVICE WITH TRANSPARENT TOUCH DISPLAY PANEL

(71) Applicant: HON HAI PRECISION INDUSTRY CO., LTD., New Taipei (TW)

(72) Inventor: CHENG-LUNG CHIANG, New Taipei (TW)

(21) Appl. No.: 13/787,816

(22) Filed: Mar. 7, 2013

(30) Foreign Application Priority Data
Nov. 22, 2012 (TW) 101143635

(51) Int. Cl. G06F 3/041

(52) U.S. Cl. CPC G06F 3/041
USPC 345/174; 345/173

(57) ABSTRACT

An exemplary electronic device includes a housing, a transparent touch display panel, electronic components, a storage unit, a power supply, and a processing unit. The transparent touch display panel is in a light permeable state when electrified by the power supply. The storage unit stores running information of the electronic components, and a lookup table. The lookup table records relationships between the electronic components and certain of the coordinates according to physical locations of the electronic components relative to the transparent touch display panel. The transparent touch display panel receives a user touch input in the light permeable state. The processing unit identifies coordinates associated with a location of the user touch input, determines which electronic component corresponds to the user touch input based on the lookup table, acquires the running information of the electronic component, and displays the acquired running information on the transparent touch display panel.

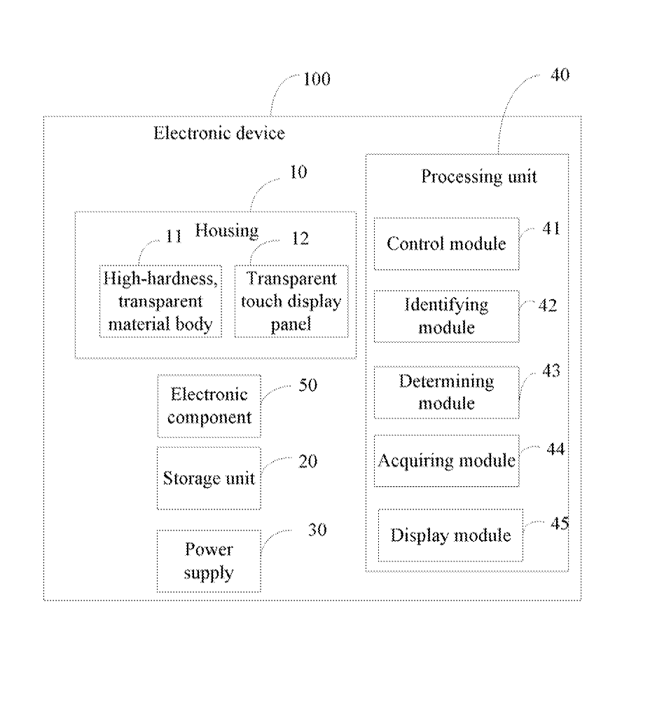

### BACKGROUND

1. Technical Field

The present disclosure relates to electronic devices, and particularly to an electronic device with a transparent touch display panel.

2. Description of Related Art

Electronic devices such as desktop computers usually include a case such as a computer case. The case includes a housing, and a number of electronic components mounted within the housing. If the electronic device malfunctions, the user typically needs to open the case to check the electronic components therein, which can be time-consuming and inconvenient.

Therefore, what is needed is a means to overcome the above described limitations.

### BRIEF DESCRIPTION OF THE DRAWING

The drawing is a block diagram of an electronic device with a transparent touch display panel in accordance with an exemplary embodiment.

### DETAILED DESCRIPTION

Referring to the drawing, an electronic device 100 is provided. The electronic device 100 includes a housing 10, a number of electronic components 50 (only one shown), a storage unit 20, a power supply 30, and a processing unit 40. The housing 10 includes a high-hardness transparent material body 11 and a transparent touch display panel 12. The high-hardness transparent material body 11 has a high surface hardness and high damage resistance, thereby helping prevent the housing 10 from being damaged. In certain embodiments, the high-hardness transparent material body 11 may be made of polycarbonate (PC), polypropylene (PP) or tempered glass. The storage unit 20 can for example be or include any kind of suitable electronic storage such as a memory, a hard disk, etc. The processing unit 40 can for example be or include a processor. The electronic components 50 may be a hard disk, a fan, a central processing unit (CPU), etc.

In the electronic device 100, a multiplicity of coordinates is electronically mapped for an entire area of the transparent touch display panel 12. Typically, the coordinates are mapped according to a regular X-Y type Cartesian plane. Certain pairs of the coordinates (each pair having an X value and a Y value) respectively correspond to the physical locations of the electronic components 50 within the electronic device 100. The storage unit 20 stores running information of each electronic component 50 being run by the electronic device 100, and a lookup table. The lookup table records relationships between the electronic components 50 and the pairs of coordinates corresponding to the physical locations of the electronic components 50.

The processing unit 40 includes a control module 41, an identifying module 42, a determining module 43, an acquiring module 44, and a display module 45. The control module 41 is able to control the power supply 30 to switch the transparent touch display panel 12 between a light permeable state and a light impermeable state. In one embodiment, the light permeable state is a state in which 50% of visible light is allowed to permeate the display panel 12. Thereby, the display panel 12 can allow the user to see the electronic components 50 inside the housing 10 without opening the housing 10, and is still able to receive and register a user touch input and display running information of any of the electronic components 50. The running information may for example be a rotating speed of the fan, an effective memory of the CPU, remaining vacant memory of the hard disk, etc. In one embodiment, the transparent touch display panel 12 is in the light permeable state when the transparent touch display panel 12 is electrified by the power supply 30, and the transparent touch display panel 12 is in the light impermeable state when the transparent touch display panel 12 is cut off from the power supply 30. In one embodiment, the transparent touch display panel 12 is a capacitive transparent touch display panel. In another embodiment, the transparent touch display panel 12 is a resistive transparent touch display panel.

In typical use of the electronic device 100, the user may believe that the electronic device 100 is malfunctioning. The transparent touch display panel 12 may already be in the light permeable state, or the user can switch the transparent touch display panel 12 from an extant light impermeable state to the light permeable state. The user views the electronic components 50 inside the housing 10, via the high-hardness transparent material body 11, and/or via the transparent touch display panel 12 if the transparent touch display panel 12 is in the light permeable state. The user speculates that a particular electronic component 50 he/she can see may be malfunctioning. The user touches the transparent touch display panel 12 at a location thereof corresponding to the particular electronic component 50. The identifying module 42 identifies specific coordinates of the coordinate information associated with the location of the user touch input on the transparent touch display panel 12. The determining module 43 determines which particular electronic component 50 the suspect electronic component 50 is, based on the identified coordinates and the lookup table. The acquiring module 44 acquires the running information of the determined electronic component 50 from the storage unit 20. The display module 45 displays the acquired running information of the determined electronic component 50 on the transparent touch display panel 12.

Although various embodiments have been specifically described, the disclosure is not to be construed as being limited thereto. Various changes or modifications may be made to the embodiments without departing from the scope and spirit of the disclosure.

What is claimed is:

1. An electronic device comprising:
a transparent touch display panel, wherein a plurality of coordinates is electronically mapped for an entire area of the transparent touch display panel;
a plurality of electronic components;
a storage unit configured to store running information of each of the electronic components being run by the electronic device, and a lookup table, wherein the lookup table records relationships between the electronic components and certain of the coordinates according to physical locations of the electronic components relative to the transparent touch display panel;
a power supply; and
a processing unit configured to control the power supply to switch the transparent touch display panel between a light permeable state and a light impermeable state;
wherein the transparent touch display panel is configured to receive a user touch input in the light permeable state, and the processing unit is further configured to identify coordinates associated with a location of the user touch input, determine which of the electronic components corresponds to the user touch input based on the identified coordinates and the lookup table, acquire the running information of the determined electronic component from the storage unit, and display the acquired running information on the transparent touch display panel.

2. The electronic device as described in claim 1, wherein further comprising a housing, wherein the housing comprises a high-hardness transparent material body and the transparent touch display panel.

3. The electronic device as described in claim 1, wherein the transparent touch display panel is a capacitive transparent touch display panel.

4. The electronic device as described in claim 1, wherein the transparent touch display panel is a resistive transparent touch display panel.

5. The electronic device as described in claim 1, wherein the transparent touch display panel is in the light permeable state when the transparent touch display panel is electrified by the power supply.
